(19) United States
(12) Patent Application Publication
(10) Pub. No.: US 2007/0083622 A1
(43) Pub. Date: Apr. 12, 2007

(54) Ethernet switch and service processing method thereof

(76) Inventors: Feng Wang, Guangdong Province (CN); Wei Wang, Guangdong Province (CN); Xuelun You, Guangdong Privince (CN); Hanguang Sun, Guangdong Province (CN); Songbo Wang, Guangdong Province (CN)

Correspondence Address: LADAS & PARRY, 5670 WILSHIRE BOULEVARD, SUITE 2100, LOS ANGELES, CA, 90036-5679, US

(21) Appl. No.: 10/548,179

(22) PCT Filed: Sep. 17, 2003
(86) PCT No.: PCT/CN03/00786

§ 371 Date: Aug. 24, 2006

(30) Foreign Application Priority Data
Mar. 5, 2003 (CN) 03119215.7

(51) Int. Cl. G06F 15/173

(52) U.S. Cl. 709/223

(57) ABSTRACT

The present invention discloses an Ethernet switch for implementing intelligent service processing, comprising: an ASIC chip designed to divert and forward received messages; a network processor, which is connected with said ASIC chip in a closed loop for message forwarding, and designed to process messages from said ASIC chip and send the processed messages back to said ASIC chip; and a CPU, which is connected with said ASIC chip and said network processor, and designed to manage and control said ASIC chip and to manage and control said network processor. The present invention also provides a method for implementing intelligent service processing using the above Ethernet switch. The Ethernet switch and the intelligent service processing method thereof according to the present invention add intelligent message processing feature to existing Ethernet switches while keep high performance of existing Ethernet switches in processing common Ethernet messages, to enable Ethernet switches to adapt to different networking environments and have good networking flexibility.

### FIELD OF THE INVENTION

The present invention relates to network communication technology, in particular to an Ethernet switch for implementing intelligent service processing in network and an intelligent service processing method thereof.

### BACKGROUND OF THE INVENTION

Presently, Ethernet switch technology, typically layer3 switch, acts an important role in construction of broadband networks. As Ethernet switch technology is used more widely, the requirement for networking capability of Ethernet switches becomes higher and higher. People not only require Ethernet switches to forward layer2 and layer3 messages quickly but also expect them to forward some intelligent service messages according to the networking demand, e.g., utilize Ethernet switches to implement Network Address Translation (NAT), detection of illegal messages, and subscriber management and authentication, etc. If Ethernet switches have above capabilities, existing application field and networking environment of Ethernet switches can be expanded and a feasible approach to turn a broadband network into a controllable, manageable, and value-added network.

FIG. 1 shows the major hardware structure of an existing Ethernet switch and its message processing flow. As shown in FIG. 1, the existing Ethernet switch mainly comprises an Application-Specific Integrated Circuit (ASIC) forwarding chip and a general-purpose CPU; the message processing flow is as follows: a message enters into the ASIC forwarding chip through an external port; the ASIC forwarding chip performs layer2 MAC+VLAN forwarding or layer3 IP route forwarding according to layer2 or layer3 attributes of the message. A large part of the message processing is accomplished in the ASIC; some control messages (e.g., messages on routing information, etc.) enter into the general-purpose CPU through a Peripheral Component Interconnect (PCI) bus of a peripheral element or an internal bus to process. In addition to control message processing, the general-purpose CPU can also perform ASIC chip configuration, forwarding table configuration, and network management.

However, for an Ethernet switch with above major structure as shown in FIG. 1, the major disadvantages are: since ASIC chip only performs forwarding of common layer2 or layer3 messages but is unable to process intelligent services (e.g., complex service processing such as policy-based routing, layer4-layer7 switching for firewall, etc.), the Ethernet switch with the main structure as shown in FIG. 1 is unable to implement intelligent service processing. The major causes are as follows: 1) at present, the message processing capability of ASIC is mainly implemented on the basis of hardware logic, while it is quite difficult to accomplish complex service processing through hardware logic; even if it is implemented, the cost will be fairly high; 2) many services are required by network subscribers in real time; however, developing such services through ASIC requires long developing cycles, and the response rate is lower. Furthermore, since that many LAN switch manufacturers use commercial ASIC chips, which can't be used to achieve special service processing.

### SUMMARY OF THE INVENTION

In view of above problems in the prior art, the present invention provides an Ethernet switch for implementing intelligent service processing and a service processing method thereof.

To attain above object, according to the first aspect of the present invention, an Ethernet switch for implementing intelligent service processing comprises: an ASIC chip designed to divert and forward received messages; a network processor, which is connected with said ASIC chip in a closed loop for message forwarding, and designed to process messages from said ASIC chip and send the processed messages back to said ASIC chip; and a CPU, which is connected with said ASIC chip and said network processor, and designed to manage and control said ASIC chip and to manage and control said network processor.

In an embodiment of the present invention, said ASIC chip is connected with said network processor through a Gigabit Media Independent Interface/Media Independent Interface/Reduced Gigabit Media Independent Interface (GMII/MII/RGMII) or Serialize/Deserialize (SERDES) converter.

In an embodiment of the present invention, said CPU is connected with said network processor and said ASIC chip through an internal bus or PCI bus.

According to the second aspect of the present invention, the present invention provides a method for implementing intelligent service processing with the Ethernet switch, said Ethernet switch comprising: an ASIC chip designed to divert and forward received messages; a network processor, which is connected with said ASIC chip in a closed loop for message forwarding, and designed to process messages from said ASIC chip and send the processed messages back to said ASIC chip; and a CPU, which is connected with said ASIC chip and said network processor, and designed to manage and control said ASIC chip and to manage and control said network processor; wherein said method comprises the following steps: 1) when messages enter into said ASIC chip through a port, said ASIC chip choosing messages to be processed by said network processor from the messages and sending the same to said network processor; 2) said network processor processing the messages according to the service attribute of them and sending the processed messages to said ASIC chip; 3) said ASIC chip forwarding the messages processed by said network processor.

Said method also comprises a step of configuring said ASIC chip and its controlling message forwarding by said CPU;

The above method also comprises a step of configuring said network processor and controlling its service processing by said CPU;

The above method further comprises a step of said ASIC chip directly forwarding the messages that needn't to be processed by said network processor and said CPU.

In said method, said step 1) further comprises a step of said ASIC chip filtering the messages through flow classification.

In an embodiment of the present invention, said ASIC chip exchanges messages with said network processor through GMII/MII/RGMII or SERDES.

The present invention has the following advantages: 1) it keeps the high performance of Ethernet switch in common Ethernet message processing and adds intelligent message processing feature, so that the Ethernet switch is adaptive to different networking environments and obtains high network flexibility; in addition, it can also quickly respond to diverse service demands of enterprise network and Campus network subscribers and contributes construction of broadband networks; 2) it combines ASIC technology, high-performance network processor technology, and control CPU technology and integrate them through different interface technologies, and thereby implementing intelligent network message management, control, and forwarding.

### BRIEF DESCRIPTION OF THE DRAWINGS

The above object and other advantages and features of the present invention can be understood better according to the following description, with reference to the attached drawings, wherein:

FIG. 1 is a schematic diagram of major hardware structure of an existing Ethernet switch and its message processing flow;

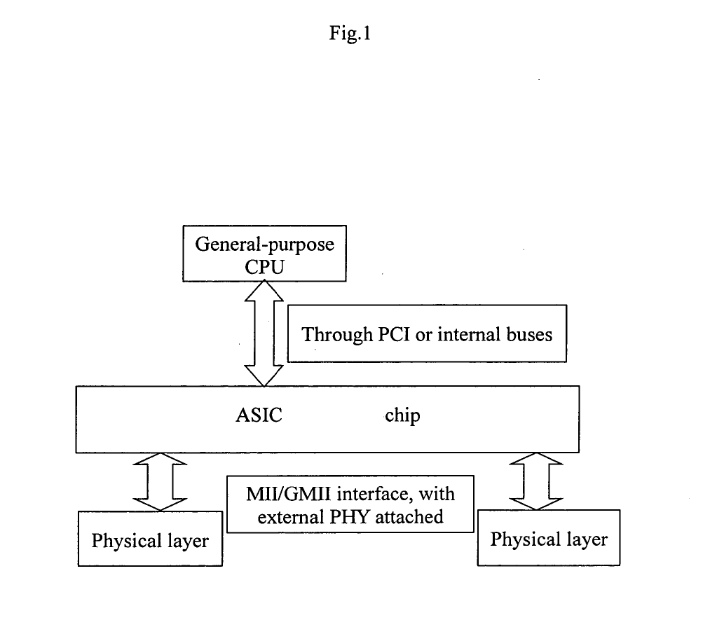

FIG. 2 is a block diagram of major structure of the Ethernet switch according to the present invention;

FIG. 3 is a block diagram of message exchange between the network processor and the ASIC according to the present invention;

FIG. 4 is a flowchart of the method for implementing intelligent service processing using said Ethernet switch according to the present invention.

### DETAILED DESCRIPTION OF THE EMBODIMENTS

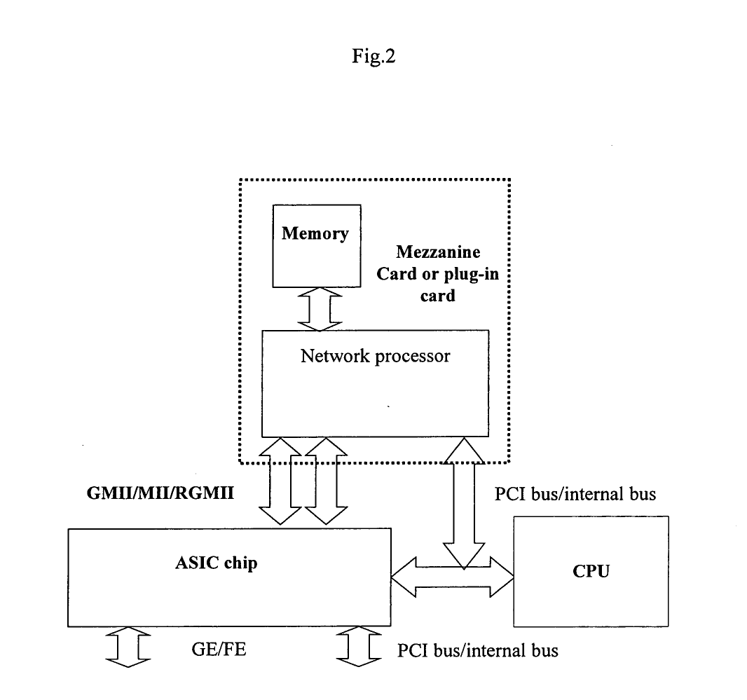

FIG. 2 is a block diagram of the major structure of said Ethernet switch according to the present invention. As shown in FIG. 2, the technical solution of the present invention is: it adds a hardware plug-in card or Mezzanine Card (mainly network processor) on the basis of hardware structure of the existing Ethernet switch, and connects the network processor and the ASIC chip through a general-purpose interface for popular ASIC chips in the market; the hardware design is mainly as follows:

1) Requirement for Selection of ASIC Forwarding Chip

The ASIC forwarding chip in the present invention shall have a certain amount of flow classification capability to divert messages to the network processor; in addition, it shall also have layer2 and layer3 message forwarding capability as well as corresponding QOS capability. Presently, most mainstream ASIC forwarding chips have above capabilities, such as 5635/5615/5690 from BROADCOM, forwarding chip GALLIEO from MARVELL, etc.

2) Requirement for Selection of the Network Processor

The network processor in the present invention is a high-performance CPU for network message processing, i.e., a programmable high-performance message processor that has emerged in the network device market recently. It can implement quick message processing through software programming. Since the present invention uses above feature of the network processor to implement processing of complex services, the requirement for the network processor is: it shall support software programming, e.g., C language or assembly language (MICROCODE), etc.; it shall have an internal bus to communicate with the general-purpose CPU; it shall has a MII/GMII for message forwarding. In addition, it can be seen from the structural block diagram of FIG. 2 that the network processor shall have at least two types of interfaces: one for the ASIC, to implement data message processing from ASIC; the other is for intercommunication with the general-purpose CPU through the internal bus, to enable the general-purpose CPU to configure it. At present, many network processors available in the market meet above requirements, such as the network processor RAINER 4GS3 from IBM, the network processor C5/C10 from MOTOROLA, and IXP1200/IXP2400 from INTEL.

3) Connection and Message Exchange Between the Network Processor and the ASIC Forwarding Chip

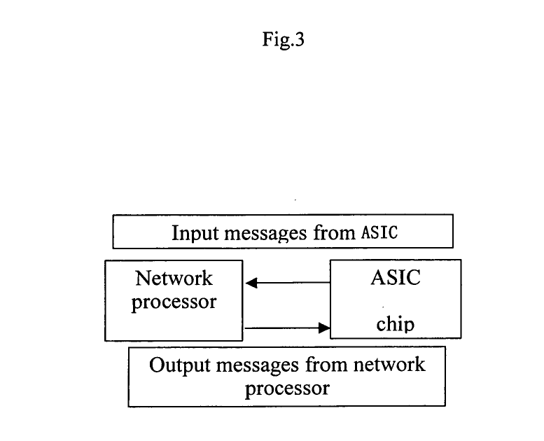

The network processor may be connected with the ASIC chip through GMII/MII/RGMII or SERDES, as long as several specific physical ports in the network processor and the ASIC are interconnected and form a closed loop for message forwarding. Since the method of connection between the network processor and the forwarding ASIC is known in this field, it will not be described further herein. The message exchange between the network processor and the ASIC is shown in FIG. 3. As shown in FIG. 3, when the messages are forwarded through the ASIC, some of them, which needs specific processing, are selected through the flow classification capability of ASIC and then forwarded to the port connected with the network processor; then, the messages directly enter into the corresponding network processor through the GMII/MII/XGMII pin; then, the network processor processes appropriately according to the attribute of the messages. After the messages are processed, the network processor sends them through the MII/GMII/XGMII pin. Finally, the ASIC forwards these messages specially processed by the network processor. Above approach implement reprocessing of special messages at the network processor, so that the service processing features that can be delivered by the LAN SWITCH ASIC are handed over to the network processor. In this way, work division and cooperation are implemented in the process, and the structure of the network devices is optimized.

4) Selection of the General-Purpose CPU

Usually, the general-purpose CPU according to the present invention shall support 64M DDR memory and shall have an internal bus used to connect with the network processor and the ASIC chip, such as PCI bus, local bus, etc. General-purpose CPUs that meet the requirement include 8240/8245/8260/750/860/850 from MOTOROLA and POWER PC series from IBM.

In the present invention, the role of the general-purpose CPU is: a) configuring the ASIC forwarding chip through the general-purpose CPU, processing routing protocols and its layer2 forwarding protocols according to the routing protocol message or the layer2 forwarding control message sent from ASIC (e.g., RIP protocol, OSPF protocol; layer2 protocols include VTP protocol, STP protocol, etc.), creating a relevant route forwarding table or protocol control table according to the processing result, and forwarding the route forwarding table or control table to ASIC as required, in order to control message forwarding at ASIC; b) controlling the network processor through the general-purpose CPU. In the present patent, the network processor is mainly responsible for service processing; the service control table (e.g., routing table, routing policy table, subscriber management information table, session table for NAT processing, and security control information table, etc.) required for service processing are sent to the network processor by the general-purpose CPU through the internal bus.

Generally speaking, the role of general-purpose CPU is to control and manage the ASIC chip and the network processor. In addition, the general-purpose CPU may also be provided with a network management port to communicate with the Network Management System and thereby implement network management of the devices.

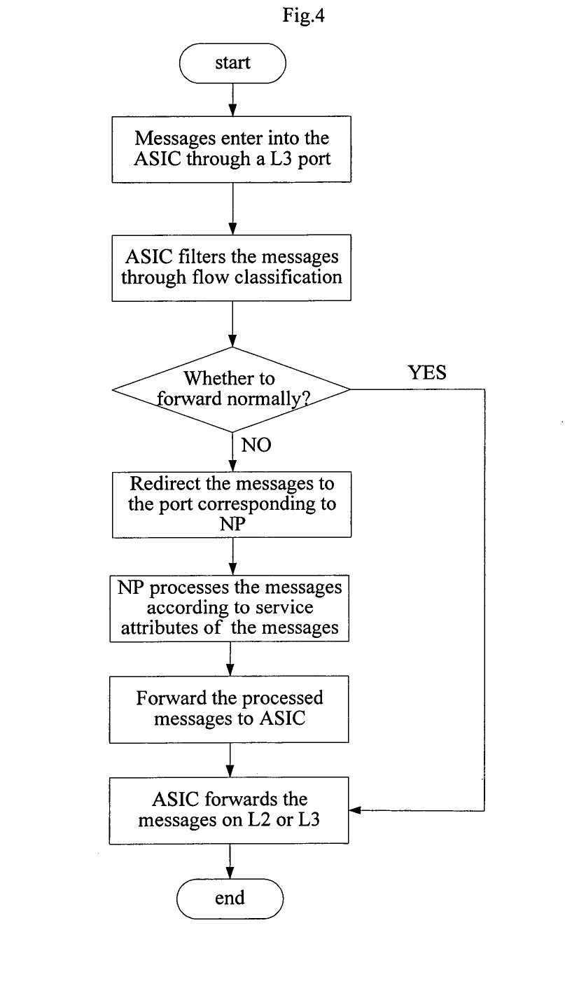

FIG. 4 is a flowchart of the method for implementing intelligent service processing using said Ethernet switch according to the present invention. As shown in FIG. 4, in step S1, messages enter into the ASIC forwarding chip through a port of the Ethernet switch. In step S2, the ASIC forwarding chip classifies and filters the messages to determine which messages are to be processed specially and which messages can be forwarded normally. Here, the ASIC may use flow classification or a similar method to classify and filter the messages, For instance, it may classify the messages by MAC address/Virtual Local Area Network ID (VLAN ID)/protocol type/source or destination IP/TCP or UDP port numbers, etc. In step S3, if the ASIC forwarding chip determines that the message needn't to be processed specially, it goes to step S7 directly and forward the message normally; on the other hand, if the ASIC forwarding chip determines that the messages need to be processed specially, it goes to step S4. In step S4, the ASIC chip sends the messages to the network processor through such as GMII/MII/XGMII or SERDES. In step S5, the network processor processes the messages correspondingly according to the service control information (e.g., the service control table) sent from the general-purpose CPU. Next, in step S6, the network processor sends the processed messages back to the ASIC. Finally, in step S7, the ASIC forwarding chip performs layer2 MAC+VLAN forwarding or layer3 IP route forwarding for the messages according to the layer2 and layer3 attributes of the messages.

Those skilled in the art should understand that though the present invention is described with reference to the embodiments as above, the embodiments shall not be deemed as constituting limitations to the present invention. The scope of the present invention shall only be defined by the attached claims.

1. An Ethernet switch, comprising:
an Application-Specific Integrated Circuit (ASIC) chip designed to divert and forward received messages;
a network processor, which is connected with said ASIC chip in a closed loop for message forwarding, and designed to process messages from said ASIC chip and send the processed messages back to said ASIC chip; and
a Central Processing Unit (CPU), which is connected with said ASIC chip and said network processor, and designed to manage and control said ASIC chip and to manage and control said network processor.

2. The Ethernet switch according to claim 1, wherein said ASIC chip is connected with said network processor through Gigabit Media Independent Interface/Media Independent Interface/Reduced Gigabit Media Independent Interface (GMII/MII/RGMII) or Serialize/Deserialize (SERDES) converter.

3. The Ethernet switch according to claim 1, wherein said CPU is connected with said network processor and said ASIC chip through an internal bus or Peripheral Component Interconnect (PCI) bus.

4. A method for implementing service processing with the Ethernet switch according to claim 1, said Ethernet switch comprising: an ASIC chip designed to divert and forward received messages; a network processor, which is connected with said ASIC chip in a closed loop for message forwarding, and designed to process messages from said ASIC chip and send the processed messages back to said ASIC chip; and a CPU, which is connected with said ASIC chip and said network processor, and designed to manage and control said ASIC chip and to manage and control said network processor; wherein said method comprises the following steps:
1) when messages enter into said ASIC chip through a port, said ASIC chip choosing messages to be processed by said network processor from the messages and sending the same to said network processor;
2) said network processor processing the messages according to the service attribute of them and sending the processed messages to said ASIC chip; and
3) said ASIC chip forwarding the messages processed by said network processor.

5. The method according to claim 4, also comprising a step of configuring said ASIC chip and its controlling message forwarding by said CPU.

6. The method according to claim 4, also comprising a step of configuring said network processor and controlling its service processing by said CPU.

7. The method according to claim 4, wherein said step 1) further comprises a step of said ASIC chip directly forwarding the messages that needn't to be processed by said network processor and said CPU.

8. The method according to claim 4, wherein said step 1) further comprises a step of said ASIC chip filtering the messages through flow classification.

9. The method according to claim 4, wherein said ASIC chip exchanges messages with said network processor through GMII/MII/RGMII or SERDES.
